(19) United States
(12) Patent Application Publication
(10) Pub. No.: US 2024/0397002 A1
(43) Pub. Date: Nov. 28, 2024

(54) JOB COMMAND GENERATION DEVICE, COMPUTER-READABLE NON-TRANSITORY RECORDING MEDIUM HAVING JOB COMMAND GENERATION PROGRAM STORED THEREIN, AND VOICE OPERATION SYSTEM

(71) Applicant: KYOCERA Document Solutions Inc., Osaka (JP)

(72) Inventors: Minoru TAKAHASHI, Osaka (JP); Kosuke NAKAJIMA, Osaka (JP); Kohei KAWANAKA, Osaka (JP)

(73) Assignee: KYOCERA Document Solutions Inc., Osaka (JP)

(21) Appl. No.: 18/670,930

(22) Filed: May 22, 2024

(30) Foreign Application Priority Data
May 26, 2023 (JP) 2023-086689

(51) Int. Cl. H04N 1/00

(52) U.S. Cl. CPC H04N 1/00082; H04N 1/00015; H04N 1/00403

(57) ABSTRACT

A job command generation device includes a control device that acts as a job command generator that manages error correction information for correcting an error in voice recognition committed by a voice reception device that converts voice data representing a received voice into text data, through the voice recognition, corrects the error in the text data received from the voice reception device, using the error correction information, and generates a job command that an image forming apparatus can interpret, on a basis of the text data in which the error has been corrected.

### INCORPORATION BY REFERENCE

This application claims priority to Japanese Patent Application No. 2023-086689 filed on May 26, 2023, the entire contents of which are incorporated by reference herein.

### BACKGROUND

The present disclosure relates to a job command generation device that generates a job command that an image forming apparatus can interpret, on the basis of text data generated by a voice reception device. The disclosure also relates to a job command generation program and a voice operation system.

A voice operation system for operating an image forming apparatus via a smart speaker, acting as a voice reception device, is widely known. In the voice operation system, a cloud service device connected to the image forming apparatus, via a network such as a local area network (LAN), generates a job command that the image forming apparatus can interpret, on the basis of the voice inputted to the smart speaker, and transmits the generated command to the image forming apparatus.

### SUMMARY

The disclosure proposes further improvement of the foregoing techniques.

In an aspect, the disclosure provides a job command generation device including a control device. The control device includes a processor, and acts, when the processor executes a job command generation program, as a job command generator that manages error correction information for correcting an error in voice recognition committed by a voice reception device that converts voice data representing a received voice into text data, through the voice recognition, corrects the error in the text data received from the voice reception device, using the error correction information, and generates a job command that an image forming apparatus can interpret, on a basis of the text data in which the error has been corrected.

In another aspect, the disclosure provides a computer-readable non-transitory recording medium, having a job command generation program stored therein. The job command generation program is configured to cause a computer to act as a job command generator that manages error correction information for correcting an error in voice recognition committed by a voice reception device that converts voice data representing a received voice into text data, through the voice recognition, corrects the error in the text data received from the voice reception device, using the error correction information, and generates a job command that an image forming apparatus can interpret, on a basis of the text data in which the error has been corrected.

In still another aspect, the disclosure provides a voice operation system including a voice reception device and a job command generation device. The voice reception device converts voice data representing a received voice into text data, through voice recognition. The job command generation device includes a control device including a processor, and configured to act, when the processor executes a job command generation program, as a job command generator that manages error correction information for correcting an error in the voice recognition committed by the voice reception device, corrects the error in the text data received from the voice reception device, using the error correction information, and generates a job command that an image forming apparatus can interpret, on a basis of the text data in which the error has been corrected.

### BRIEF DESCRIPTION OF THE DRAWINGS

FIG. 1 is a block diagram showing a configuration of a voice operation system according to an embodiment of the disclosure;

FIG. 2 is a block diagram showing a configuration of the smart speaker shown in FIG. 1;

FIG. 3 is a block diagram showing a configuration of the job command generation device shown in FIG. 1, constituted of a single computer;

FIG. 4 is a block diagram showing a configuration of the image forming apparatus shown in FIG. 1, set up as an MFP;

FIG. 5 is a flowchart showing an example of an operation for processing a voice to operate the image forming apparatus, performed by the smart speaker shown in FIG. 2;

FIG. 6 is a flowchart showing another example of the operation for processing a voice to operate the image forming apparatus, performed by the smart speaker; and

FIG. 7 is a flowchart showing an operation performed by the job command generation device shown in FIG. 3, when text data is received from the smart speaker.

### DETAILED DESCRIPTION

Hereafter, a job command generation device, a job command generation program, a computer-readable non-transitory recording medium having the job command generation program stored therein, and a voice operation system according to an embodiment of the disclosure will be described, with reference to the drawings.

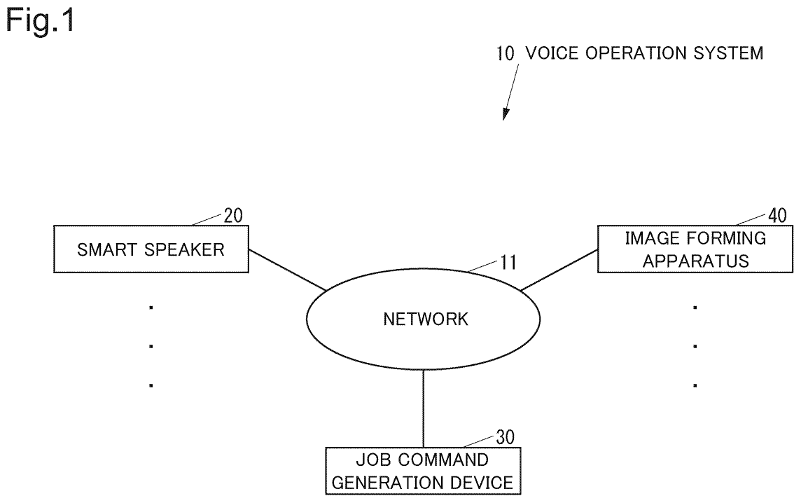

First, a configuration of the voice operation system according to the embodiment of the disclosure will be described. FIG. 1 is a block diagram showing a configuration of the voice operation system 10 according to the embodiment.

As shown in FIG. 1, the voice operation system 10 includes a smart speaker 20, a job command generation device 30, and an image forming apparatus 40. The smart speaker 20 acts as a voice reception device that receives a voice inputted by a user. The voice operation system 10 may include, in addition to the smart speaker 20, one or more smart speakers configured similarly to the smart speaker 20. The smart speaker is configured to convert voice data, representing the received voice, into text data through voice recognition.

The job command generation device 30 generates a job command that the image forming apparatus 40, to be subsequently described, can interpret (hereinafter, simply “job command”), on the basis of the text data generated by the smart speaker 20. The job command generation device 30 may be constituted of a single computer, or a plurality of computers.

The image forming apparatus 40 may be, for example, a single-purpose printer, or a multifunction peripheral (MFP). The voice operation system 10 may include, in addition to the image forming apparatus 40, one or more image forming apparatuses configured similarly to the image forming apparatus 40.

In the voice operation system 10, the smart speaker communicates with the job command generation device 30, via a network 11 such as a local area network (LAN), or the internet.

In the voice operation system 10, the job command generation device 30 mutually communicates with the image forming apparatus 40, for example via the network 11.

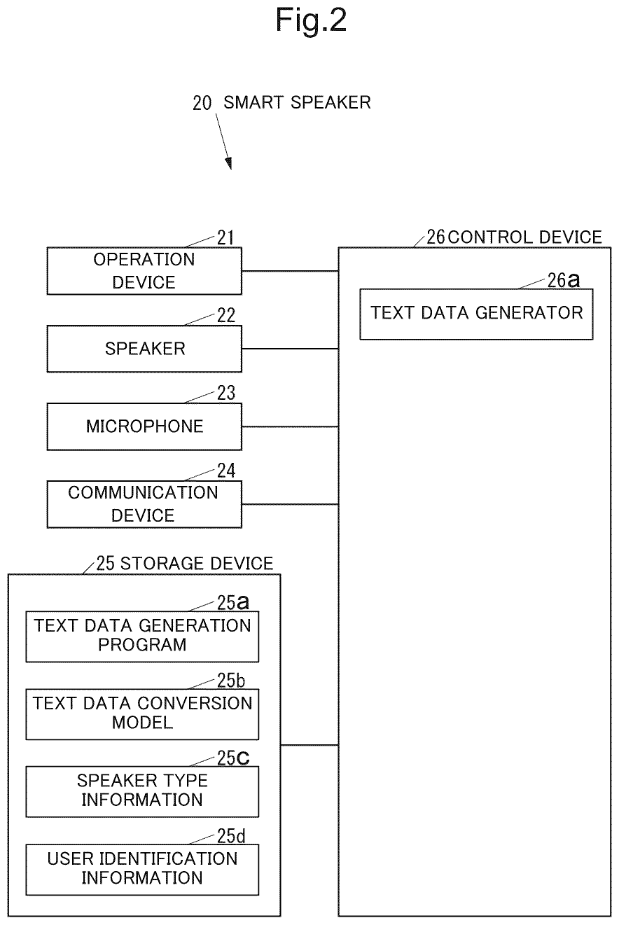

FIG. 2 is a block diagram showing a configuration of the smart speaker shown 20. As shown in FIG. 2, the smart speaker 20 includes an operation device 21, for example including buttons, for inputting various instructions, a speaker 22, a microphone 23, a communication device 24 that performs communication with external devices, via a network such as a LAN or the internet, or directly via wired or wireless communication instead of using the network, a storage device 25 constituted of a non-volatile memory such as a semiconductor memory or a hard disk drive (HDD), for storing various types of information, and a control device 26 that controls the entirety of the smart speaker 20.

The storage device 25 contains a text data generation program 25a for generating text data on the basis of voice data. The text data generation program 25a may be installed in the smart speaker 20, for example in the manufacturing process thereof. Alternatively, the text data generation program 25a may be additionally installed from an external storage medium, such as a universal serial bus (USB) memory, or from a network. The text data generation program 25a is stored in a computer-readable non-transitory recording medium, for example a compact disc (CD), the USB memory, or the storage device 25.

The storage device 25 contains a text data conversion model 25b, which is a machine learning model for converting the voice data into the text data, through voice recognition.

The storage device 25 contains speaker type information 25c, indicating the type of the smart speaker 20 itself. The type of the smart speaker 20 may be expressed by the model name of the smart speaker 20, or by the name of the manufacturer of the smart speaker 20.

The storage device 25 contains user identification information 25d, indicating the identification information of the user of the smart speaker 20. The user identification information 25d may be, for example, the e-mail address of the user of the smart speaker 20.

The control device 26 includes a microprocessor, for example including a central processing unit (CPU) acting as a computer, a read-only memory (ROM) containing programs and various types of data, and a random-access memory (RAM) to be utilized as an operation region by the CPU of the control device 26. The microprocessor of the control device 26 executes the programs stored in the storage device 25 or the ROM of the control device 26.

The control device 26 acts as a text data generator 26a that generates the text data on the basis of the voice data, when the microprocessor executes the text data generation program 25a.

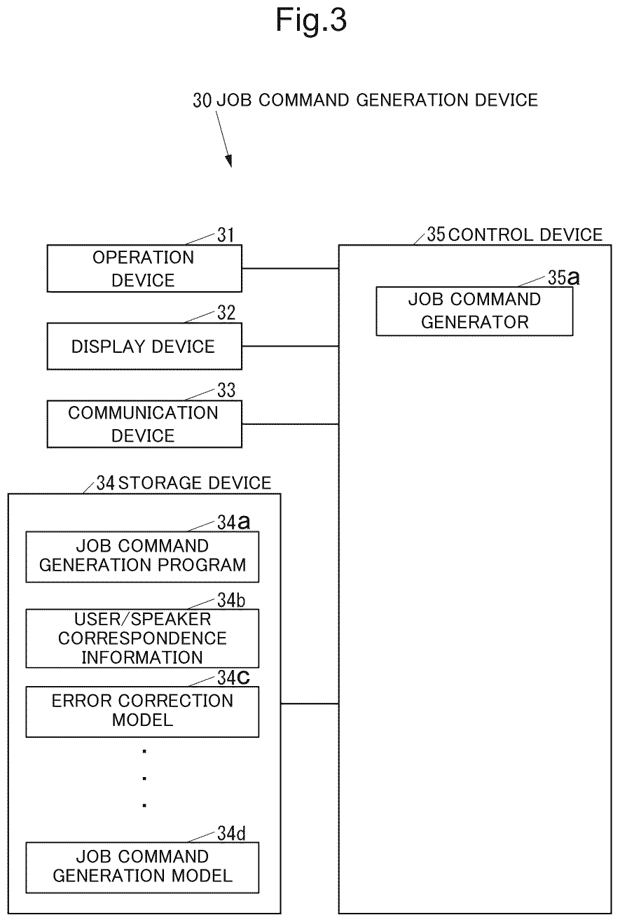

FIG. 3 is a block diagram showing a configuration of the job command generation device 30, constituted of a single computer.

As shown in FIG. 3, the job command generation device 30 includes an operation device 31, for example including a keyboard and a mouse, for inputting various instructions, a display device 32 for example including a liquid crystal display (LCD) for displaying various types of information, a communication device 33 that performs communication with external devices, via a network such as a LAN or the internet, or directly via wired or wireless communication instead of using the network, a storage device 34 constituted of a non-volatile memory such as a semiconductor memory or an HDD, for storing various types of information, and a control device 35 that controls the entirety of the job command generation device 30.

The storage device 34 contains a job command generation program 34a for generating a job command on the basis of the text data. The job command generation program 34a may be installed in the job command generation device 30, for example in the manufacturing process thereof. Alternatively, the job command generation program 34a may be additionally installed from an external storage medium, such as a universal serial bus (USB) memory, or from a network. The job command generation program 34a is stored in a computer-readable non-transitory recording medium, for example a compact disc (CD), the USB memory, or the storage device 25.

The storage device 34 contains user/speaker correspondence information 34b indicating the correspondence between the user identification information and the speaker type information indicating the type of the smart speaker used by the user. In other words, the job command generation device 30 is managing the correspondence between the type of the smart speaker and the user identification information of the user of the smart speaker. The control device 35 may register the correspondence between the user identification information and the speaker type information in the user/speaker correspondence information 34b, according to an instruction from the user, or according to a notice from the smart speaker, in which the user identification information and the speaker type information are stored.

The storage device 34 contains an error correction model 34c, which is a machine learning model representing error correction information for correcting an error in the voice recognition by the smart speaker. At least one error correction model may be stored in the storage device 34, in addition to the error correction model 34c. In the storage device 34, the error correction model is stored with respect to each of the types of the smart speaker. In other words, the job command generation device 30 manages the error correction model, with respect to each of the types of the smart speaker. The error correction model may be generated through machine learning, based on an enormous amount of learning data containing the text data generated through voice recognition by the smart speaker, and the correct answer data to the text data. Therefore, the error correction information stored in the storage device 34 can be rewritten.

The storage device 34 contains a job command generation model 34d, which is a machine learning model for interpreting the text data, to thereby generate the job command.

The control device 35 includes a microprocessor, for example including a central processing unit (CPU) acting as a computer, a read-only memory (ROM) containing programs and various types of data, and a random-access memory (RAM) to be utilized as an operation region by the CPU of the control device 35. The microprocessor of the control device 35 executes the programs stored in the storage device 34 or the ROM of the control device 35.

The control device 35 acts as a job command generator 35a that generates the job command on the basis of the text data, when the microprocessor executes the job command generation program 34a.

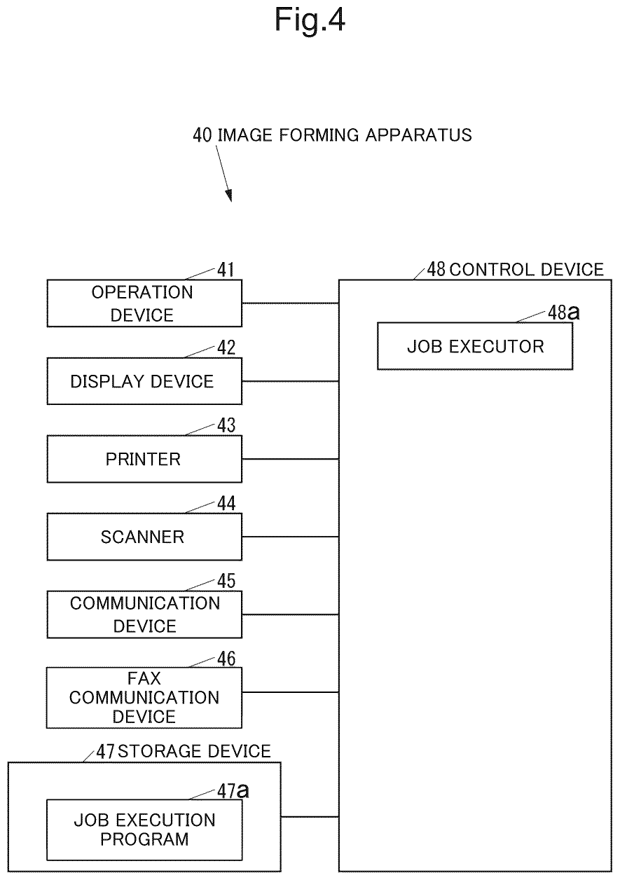

FIG. 4 is a block diagram showing a configuration of the image forming apparatus 40, set up as an MFP.

As shown in FIG. 4, the image forming apparatus 40 includes an operation device 41, for example including buttons, for inputting various instructions, a display device 42 for example including a liquid crystal display (LCD) for displaying various types of information, a printer 43 that prints an image on a recording medium such as a sheet, a scanner 44 that reads an image from a source document, a communication device 45 that performs communication with external devices, via a network such as a LAN or the internet, or directly via wired or wireless communication instead of using the network, a fax communication device 46 that performs facsimile communication with non-illustrated external facsimile machines, via a communication network such as the public telephone network, a storage device 47 constituted of a non-volatile memory such as a semiconductor memory or an HDD, for storing various types of information, and a control device 48 that controls the entirety of the image forming apparatus 40.

The storage device 47 contains a job execution program 47a for generating a job. The job execution program 47a may be installed in the image forming apparatus 40, for example in the manufacturing process thereof. Alternatively, the job execution program 47a may be additionally installed from an external storage medium, such as a universal serial bus (USB) memory, or from a network. The job execution program 47a is stored in a computer-readable non-transitory recording medium, for example a compact disc (CD), the USB memory, or the storage device 25.

The control device 48 includes a microprocessor, for example including a CPU acting as a computer, a ROM containing programs and various types of data, and a RAM to be utilized as an operation region by the CPU of the control device 48. The microprocessor of the control device 48 executes the programs stored in the storage device 47 or the ROM of the control device 48.

The control device 48 acts as a job executor 48a that executes a job, when the microprocessor executes the job execution program 47a.

Hereunder, an operation of the voice operation system 10, for operating the image forming apparatus through the smart speaker, will be described. In the following description, it will be assumed that the image forming apparatus that is the object of the voice operation, to be performed through the smart speaker 20, is the image forming apparatus 40.

First, an operation of the smart speaker 20 for receiving a voice for operating the image forming apparatus 40 will be described.

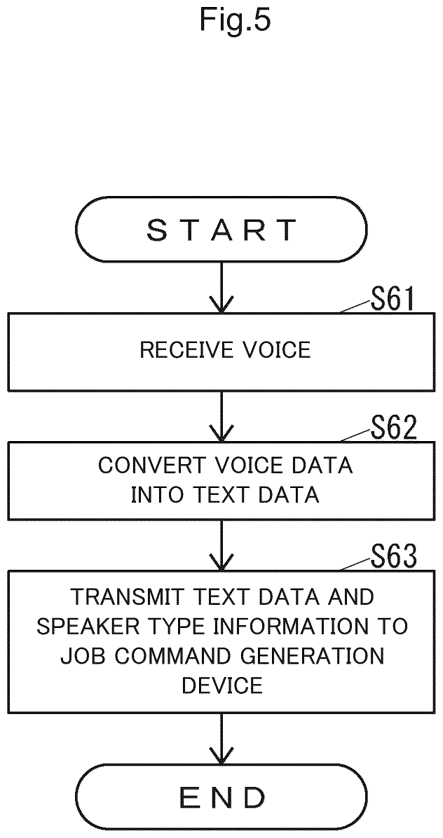

FIG. 5 is a flowchart showing an example of the operation performed by the smart speaker 20, upon receipt of the voice for operating the image forming apparatus 40.

The user outputs a voice indicating the operation that the image forming apparatus 40 is to perform, thereby inputting the voice to the microphone 23 of the smart speaker 20.

When such voice is inputted to the microphone 23 (S61), the text data generator 26a of the smart speaker 20 converts the voice data representing the inputted voice into text data, using the text data conversion model 25b (S62).

After S62 is done, the text data generator 26a transmits the text data generated at S62, and the speaker type information 25c stored in the storage device 25, to the job command generation device 30 through the communication device 24 (S63). Thereafter, the operation shown in FIG. 5 is finished

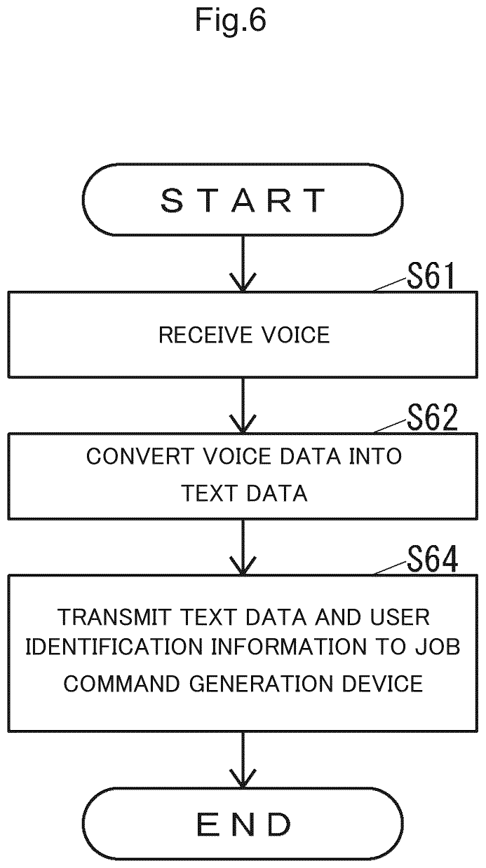

FIG. 6 is a flowchart showing another example of the operation performed by the smart speaker 20, upon receipt of the voice for operating the image forming apparatus 40.

When a voice is inputted to the microphone 23, the text data generator 26a of the smart speaker 20 may execute the operation shown in FIG. 6, instead of the operation shown in FIG. 5.

The operation shown in FIG. 6 is the same as the operation shown in FIG. 5, except that the step of S63 (FIG. 5) is substituted with a step of S64.

As shown in FIG. 6, after S62 is done, the text data generator 26a transmits the text data generated at S62, and the user identification information representing the same content as the user identification information 25d stored in the storage device 25, to the job command generation device 30 through the communication device 24 (S64). Thereafter, the operation shown in FIG. 6 is finished

Hereunder, an operation of the job command generation device 30, performed upon receipt of the text data from the smart speaker 20, will be described.

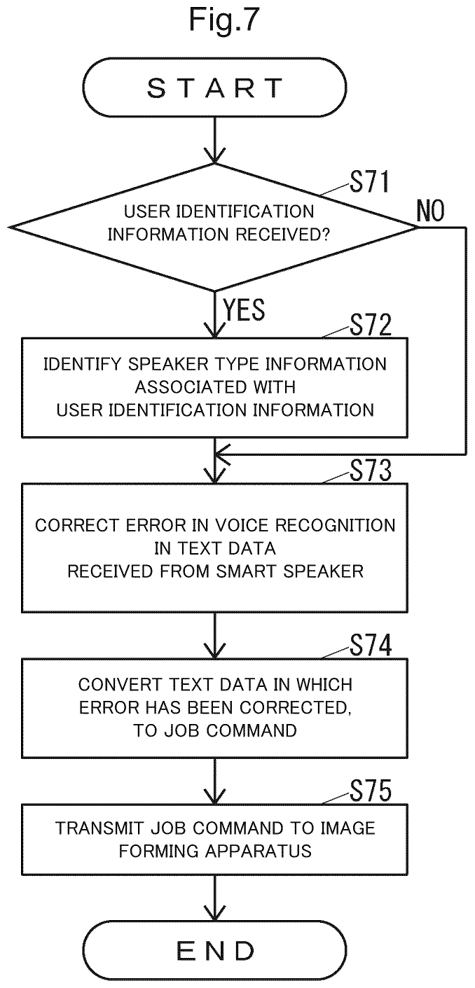

FIG. 7 is a flowchart showing the operation performed by the job command generation device 30, when the text data is received from the smart speaker 20.

Upon receipt of the text data transmitted from the smart speaker 20 at S63 (FIG. 5) or S64 (FIG. 6), through the communication device 33, the job command generator 35a of the job command generation device 30 decides whether the user identification information has been received together with the text data, from the smart speaker 20 (S71).

Upon deciding that the user identification information has been received together with the text data, from the smart speaker 20 (YES at S71), the job command generator 35a identifies the speaker type information associated with the user identification information, received together with the text data from the smart speaker 20, on the basis of the user/speaker correspondence information 34b (S72).

In the case where the user identification information has not been received from the smart speaker 20 together with the text data (NO at S71), in other words when the speaker type information has been received from the smart speaker 20 together with the text data, instead of the user identification information, and when the S72 has been done, the job command generator 35a corrects one or more errors in the voice recognition, contained in the text data received from the smart speaker 20 (S73), using the error correction model corresponding to the type of the smart speaker indicated by the speaker type information received from the smart speaker 20 together with the text data (in the case of NO at S71), or the speaker type information identified at S72 (in the case of YES at S71).

For example, when a voice “duplex copy” is inputted at S51 of FIG. 5 or FIG. 6, the text data generator 26a may erroneously generate the text data as “duplex coffee”, instead of “duplex copy”, at S62. Accordingly, when the text data as “duplex coffee”, for example, is received from the smart speaker 20, the job command generator 35a generates the text data as “duplex copy” at S73, using the error correction model. This is because the error correction model contains many incorrect words, for example “coffee” and “cuppy”, with respect to the correct answer “copy”, and is used to convert a word included in the incorrect words, to the corresponding word of the correct answer.

After S73 is done, the job command generator 35a converts the text data generated at S73 into the job command, using the job command generation model 34d (S74). For example, when the text data generated at S73 represents “duplex copy”, the job command generator 35a generates the job command including “job type: copy” and “printing face: duplex” at S74, so that the image forming apparatus 40 can understand.

After S74 is done, the job command generator 35a transmits the job command generated at S74, to the image forming apparatus 40 through the communication device 33 (S75). Thereafter, the operation shown in FIG. 7 is finished.

Upon receipt of the job command transmitted from the job command generation device 30 at S75, through the communication device 45, the job executor 48a of the image forming apparatus 40 executes the job indicated by the job command received. For example, when the job command transmitted from the job command generation device 30 at S75 includes “job type: copy” and “printing face: duplex”, the job executor 48a executes the job of producing a duplex copy.

As described above, the job command generation device 30 corrects, using the error correction model, the error in the voice recognition contained in the text data received from the smart speaker 20 (S73), which converted the voice data representing the voice received at S61 into the text data at S62, and generates the job command that the image forming apparatus can interpret, on the basis of the text data in which the error in the voice recognition has been corrected (S74). Therefore, the image forming apparatus 40 can operate with higher accuracy, in accordance with the intention of the user, in the operation in which the smart speaker 20, configured to convert the voice data into the text data through the voice recognition, is involved. In particular, the job command generation device 30 corrects the error in the voice recognition contained in the text data received from the smart speaker 20, using the error correction model corresponding to the type of the smart speaker 20 (S73). Therefore, the image forming apparatus 40 can operate with higher accuracy, in accordance with the intention of the user, in the operation in which the smart speaker 20, configured to convert the voice data into the text data through the voice recognition, is involved.

Here, in the case where the image forming apparatus 40 fails to operate in accordance with the intention of the user, because of the error in the voice recognition committed by the smart speaker 20, one of possible solutions is to improve the accuracy of the voice recognition by the smart speaker 20. However, normally it is difficult for a party other than the manufacturer of the smart speaker 20, to improve the accuracy of the voice recognition by the smart speaker 20. With the job command generation device 30, the image forming apparatus 40 can operate with higher accuracy, in accordance with the intention of the user, without the need to improve the accuracy of the voice recognition by the smart speaker 20.

The job command generation device 30 corrects the error in the voice recognition contained in the text data received from the smart speaker 20, using the error correction model corresponding to the type of the smart speaker 20, associated with the user identification information received from the smart speaker 20 in relation to the text data (YES at S71, and S72, S73). Therefore, the image forming apparatus 40 can operate with higher accuracy, in accordance with the intention of the user, despite the type of the smart speaker 20 not having been transmitted from the smart speaker 20. According to this embodiment, the job command generation device 30 uses the error correction model corresponding to the type of the smart speaker. Instead, the job command generation device 30 may use a single error correction model, irrespective of the type of the smart speaker.

In the case of the voice operation system not based on the above embodiments, the voice data representing the voice inputted to the smart speaker is converted by the cloud service device into the text data through the voice recognition. Accordingly, the type of the smart speaker that converts the voice data into the text data through the voice recognition is not taken into consideration, when the conversion is performed. In addition, in such a voice operation system, the image forming apparatus fails to operate in accordance with the intention of the user, when the voice recognition is erroneously performed.

According to the foregoing embodiment, unlike the above, the image forming apparatus 40 can operate with higher accuracy, in accordance with the intention of the user, in the operation in which the voice reception device, configured to convert the voice data into the text data through the voice recognition, is involved.

According to the foregoing embodiment, the error correction information represents the error correction model. However, the error correction information according to the embodiment may be information other than the machine learning model. For example, the error correction information according to the embodiment may represent simple conversion of a specific character string into another specific character string, such as simply converting the character string “coffee” into the character string “copy”. However, when the error correction information represents the error correction mode, the job command generation device 30 corrects the text data in consideration of the feature of the sentence, such as the position of the word in the sentence in the text data, and therefore the accuracy in correction of the text data can be improved, compared with the case where the error correction information represents simple conversion of a specific character string into another specific character string.

While the present disclosure has been described in detail with reference to the embodiments thereof. it would be apparent to those skilled in the art that various changes and modifications may be made therein, within the scope defined by the appended claims.

What is claimed is;

1. A job command generation device, comprising a control device including a processor, and configured to act, when the processor executes a job command generation program, as a job command generator that:
manages error correction information for correcting an error in voice recognition committed by a voice reception device that converts voice data representing a received voice into text data, through the voice recognition;
corrects the error in the text data received from the voice reception device, using the error correction information; and
generates a job command that an image forming apparatus can interpret, on a basis of the text data in which the error has been corrected.

2. The job command generation device according to claim 1, further comprising a storage device in which the error correction information is stored,
wherein the error correction information stored in the storage device can be rewritten.

3. The job command generation device according to claim 1, further comprising a communication device that transmits the job command generated by the job command generator, to the image forming apparatus.

4. The job command generation device according to claim 1,
wherein the job command generator is configured to:
manage the error correction information with respect to each of types of the voice reception device; and
correct the error in the text data received from the voice reception device, using the error correction information corresponding to the type of the voice reception device.

5. The job command generation device according to claim 2,
wherein the job command generator is configured to:
manage corresponding between a type of the voice reception device and identification information of a user of the voice reception device; and
correct the error in the text data received from the voice reception device, using the error correction information corresponding to the type of the voice reception device associated with the identification information received from the voice reception device in relation to the text data.

6. A computer-readable non-transitory recording medium, having a job command generation program stored therein, the job command generation program being configured to cause a computer to act as a job command generator that:
manages error correction information for correcting an error in voice recognition committed by a voice reception device that converts voice data representing a received voice into text data, through the voice recognition;
corrects the error in the text data received from the voice reception device, using the error correction information; and
generates a job command that an image forming apparatus can interpret, on a basis of the text data in which the error has been corrected.

7. A voice operation system comprising:
a voice reception device that converts voice data representing a received voice into text data, through voice recognition; and
a job command generation device that generates a job command that an image forming apparatus can interpret,
wherein the job command generation device includes a control device including a processor, and configured to act, when the processor executes a job command generation program, as a job command generator that:
manages error correction information for correcting an error in the voice recognition committed by the voice reception device;
corrects the error in the text data received from the voice reception device, using the error correction information; and
generates the job command that the image forming apparatus can interpret, on a basis of the text data in which the error has been corrected.
